(19) United States
(12) Patent Application Publication
(10) Pub. No.: US 2006/0212359 A1
(43) Pub. Date: Sep. 21, 2006

(54) System and method for selecting a service provider

(76) Inventor: Douglas Robert Hudgeon, New South Wales (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/516,036

(22) PCT Filed: May 23, 2003
(86) PCT No.: PCT/AU03/00636

§ 371 Date: Jul. 7, 2005

(30) Foreign Application Priority Data
May 23, 2002 (AU) PS 2468
Jul. 4, 2002 (AU) PS 3385
Jul. 23, 2002 (AU) 2002950348
Dec. 2, 2002 (US) 10/308519
Jan. 24, 2003 (AU) 2003200220

(51) Int. Cl. G06Q 30/00

(52) U.S. Cl. 705/26

(57) ABSTRACT

The invention provides a selection system and method to facilitate the provision of services on a computer network to prospective service users. In a preferred embodiment a computerised method of enabling a buyer to select a service provider for performing a service is described. The method includes processing a service enquiry for a particular service, and retrieving historical cost or invoicing data associated with said service in respect of a plurality of service providers in response to the enquiry. The historical cost data is processed to arrive at comparable cost data for enabling the selection of a service provider to perform the particular service. Cost or invoicing data relating to the provision of the particular service by the selected service provider is then captured, and the historical cost data is updated by incorporating the captured cost data. In this way, separate quoting or tendering is eliminated and job selection is effectively based on historical invoicing data.

### FIELD OF THE INVENTION

The present invention relates to a system and method for allowing a service user to quantify and compare the desirability of competing service providers, and to select a service provider to perform a particular service.

### BACKGROUND OF THE INVENTION

Potential purchasers of goods are often able to choose the product most appropriate to their needs by examining the product and assessing the quality of its construction and its suitability to the purchaser's needs. Usually, the price of the goods is known and therefore the purchaser may be able to base their purchase decision on a cost/benefit analysis of the product.

In contrast to goods, potential users of a service generally do not have the same level of information available to them on which to base their selection of a service provider. Therefore the process of ascertaining which service provider is the most appropriate, efficient and/or cost effective provider to perform a job can be a complex, time consuming and inexact process.

Traditionally services have been procured using a tendering process. Participating service providers prepare a proposal in response to a tender request made by the service user. The service user can then compare the proposals and select the most desirable service provider.

As the need for the service user to perform research into the potential service providers is reduced, the service users perceive that there is a time and cost advantage to them in using a tender system. However, the perceived advantages of a tender system may not be home out in actuality for a number of reasons. For example, the tender documents from all of the potential suppliers may not be readily comparable due to different terminology, methodology or charging practices of the suppliers, and hence additional effort is required to perform the comparison between the various tender responses received. Furthermore, in situations where a service user (or group of service users) have a large number of low cost jobs to be performed, the time and effort expended in compiling, reviewing and comparing tenders may make using a tendering process both slow and uneconomical for both buyers and sellers.

In particular, a tendering system may also become disadvantageous for the suppliers when the cost and effort required to submit a tender for a job outweighs the profit of performing the job.

In order to address the identified disadvantages of prior art service procurement methods, International patent application PCT/AU01/00660 to the applicant proposes a system and method for facilitating the selection of a service provider to perform a job. The system described therein uses the current rates charged by each service provider to estimate a cost effectiveness ranking for each service provider and allows the buyer to select a service provider based on this information.

It has been found by the present inventors that the system disclosed in International application PCT/AU01/00660 has a number of disadvantages. A system of this type is time consuming for sellers, as the sellers are required to enter rates or quotes into the system regularly to obtain work. The system described therein is also susceptible to manipulation by service providers who wish to win additional work This can be done by a service provider inputting lower than market value rates into the system in order to obtain a more favourable cost effectiveness ranking. However, when it comes to the provision of the service the final invoiced cost of the job to the buyer may include the cost of extra items or service time in addition to that requested, surcharges etc. In such cases the predicted cost effectiveness of the service provider is not accurate.

### SUMMARY OF THE INVENTION

According to a first aspect the present invention provides a computerised method of enabling a buyer to select a service provider for performing a service; said method including the steps of:

(a) processing a service enquiry for a particular service;

(b) retrieving historical cost data associated with said service in respect of a plurality of service providers in response to said enquiry;

(c) processing said historical cost data to arrive at comparable cost data in respect of said service providers for enabling the selection of a service provider to perform the particular service;

(d) capturing cost data relating to the provision of the particular service by the selected service provider, and

(e) updating the historical cost data by incorporating said captured cost data

Conveniently, the method includes the additional steps of repeating steps (a) to (e) to enable a buyer to select a service provider for the provision of subsequent services with the aid of regularly updated cost data

Advantageously, the method includes the step of compiling an historical cost dataset including historical cost data associated with the provision of at least one similar previous service by each service provider.

Typically, the service enquiry includes a plurality of service components and the historical cost data includes historical cost data for a plurality of comparable service components, and step (c) includes the sub-step of:

processing said historical cost data to arrive at cost data for each of said service components.

The cost data captured in step (d) may include cost data for each of the service components included in the service enquiry.

The service components may include cost per unit of time and distance, in combination with units of time and distance.

Preferably, the method includes the steps of

(f) retrieving historical quality data associated with said service in respect of a plurality of service providers in response to said enquiry; and

(g) processing said historical quality data to arrive at comparable quality data in respect of said service providers to enable the selection of a service provider to perform the particular service.

The method may include the further steps of:

(h) capturing quality data relating to the provision of the particular service by the selected service provider; and

(i) updating the historical quality data to reflect said captured quality data.

Steps (f) to (i) are typically repeated to assist a buyer to select a service provider for the provision of subsequent services with the aid of regularly updated quality data.

The method may include the step of compiling an historical quality dataset including historical quality data associated with the provision of at least one previous service by each service provider.

The historical quality data may include historical quality data for a plurality of performance attributes, and the service request enquiry may include a plurality of comparable performance attribute weightings reflecting the relative importance of at least two of the performance attributes to the buyer.

Step (g) typically includes the sub-step of processing said historical quality data in respect of each of the performance attributes to arrive at comparable performance data in respect of each performance attribute, and combining said comparable performance data according to performance attribute weightings contained in the service enquiry for each service provider, to generate said comparable quality data.

The method may include the step of quantifying the selected quality factors using any derived scale, weighting such factors according to their relative importance, normalising the factors and combining them with the similarly normalised historical cost factors, in combination with an additional weighting factor.

By the term “quality data” is meant any non price-related factor which may influence the decision of the buyer to select a particular seller. Typical examples include effectiveness and result factors, level of competence comprehensiveness, turn-around or implementation time, completeness, value added components, safety factors, and the like.

The comparable cost data and comparable quality data in respect of each of the service providers may be combined to derive a comparable performance index for each service provider for enabling the selection of a service provider to perform the particular service, with the combination of the comparable cost data and comparable quality data being arranged in accordance with weightings reflecting the relative importance of the comparable cost data and comparable quality data to the buyer.

The historical cost data can preferably include corresponding historical service enquiry data, and the step of processing said historical cost data can include processing said related service enquiry data to arrive at comparable cost data.

Preferably the method includes the steps of capturing service enquiry data associated with the captured cost data, and updating the historical cost data by incorporating said captured service enquiry data.

According to a second aspect of the invention there is provided a computerised method of enabling a buyer to select, a service provider for performing a service, said method including the steps of:

(a) compiling historical cost and quality datasets including historical cost and quality data associated with the provision of at least one previous service by each service provider.

(b) receiving and processing a service enquiry from the buyer for a particular service;

(c) retrieving historical cost and quality data associated with said service in respect of a plurality of service providers in response to said enquiry; and

(d) processing said historical cost and quality data to arrive at comparable cost and quality data in respect of said service providers for enabling the selection of a service provider to perform the particular service.

The method preferably includes the subsequent steps of:

(e) capturing cost and quality data relating to the provision of the particular service by the selected service provider;

(f) updating the historical cost and quality data to incorporate said captured cost and quality data, and repeating steps (b) to (f) to enable a buyer to select a service provider for the provision of subsequent services.

The method may include the steps of formatting the service enquiry into a plurality of service components, and formatting the historical cost and quality data into a plurality of comparable service components, with step (d) including the sub-step of:

processing said historical cost and quality data to arrive at cost and quality data for each of said components.

The invention extends to a computer-readable medium having stored thereon executable instructions for causing a computer to perform a method of enabling a buyer to select a service provider for performing a service; said method including the steps of:

(a) processing a service enquiry for a particular service;

(b) retrieving historical cost data associated with said service in respect of a plurality of service providers in response to said enquiry,

(c) processing said historical cost data to arrive at comparable cost data in respect of said service providers for enabling the selection of a service provider to perform the particular service;

(d) capturing cost data relating to the provision of the particular service by the selected service provider, and

(e) updating the historical cost data by incorporating said captured cost data.

Preferably, the computer-readable medium has further executable instructions for causing a computer to repeat steps (a) to (e) to enable a buyer to select a service provider for the provision of subsequent services with the aid of regularly updated cost data.

The invention also provides a computer operating under the control of the computer readable medium.

The executable instructions may be in web-compatible Mark-up language such as HTML, XML, or XML/EDI.

According to a still further aspect of the invention there is provided a computer system to enable a buyer to select a service provider for performing a service; said system including:

enquiry processing means configured to receive and process a service enquiry for a particular service from the buyer,

a database configured to store historical cost data associated with said service in respect of a plurality of service providers;

a processor adapted to retrieve and process said historical cost data from said database in response to said query to arrive at comparable cost data in respect of said service providers for enabling the buyer to select a service provider, on the basis of said comparable cost data, to perform the particular service.

Preferably, the computer system includes data capture means configured to capture cost data relating to the provision of the particular service by the selected service provider; and updating means to update the historical cost data on the database with said captured cost data.

Typically, the enquiry processing means is configured to retrieve historical quality data associated with said service in respect of a plurality of service providers in response to said enquiry, and the processing means is configured to generate comparable quality data from said historical quality data in respect of said service providers.

The historical quality data typically includes historical quality data for a plurality of performance attributes, and the service request enquiry includes a plurality of comparable performance attribute weightings reflecting the importance of each of the performance attributes to the buyer.

The processor may be configured to process said historical quality data in respect of each of the performance attributes to arrive at comparable performance data in respect of each performance attribute, and to combine the comparable performance data according to the performance attribute weightings included in the service enquiry for each service provider, to generate said comparable quality data.

The processor may be configured to derive a comparable performance index for each service provider by combining the comparable cost data and comparable quality data in respect of each of the service providers with the combination of the comparable cost data and comparable quality data being is performed in accordance with weightings reflecting the relative importance of the comparable cost data and comparable quality data to the buyer.

The invention further provides a computer system to enable a buyer to select a service provider for performing a service; said system including:

a database configured to store a first dataset including a plurality of service providers, a plurality of associated services and a plurality of associated historical costs;

a processor in communication with said database, wherein said processor is configured to receive historical cost data associated with each service provider and to generate comparative cost data for each service provider according to a predetermined algorithm; and

communication means configured to communicate said comparative cost data to said buyer to enable the buyer to select a service provider.

Preferably, the predetermined algorithm includes weighting means configured to weight a plurality of received historical cost data according to the respective associated service of the historical cost data, and to generate the comparative cost data in accordance with said weighting.

Conveniently, the processor includes weighting optimisation means adapted to optimise the weightings applied by the weighting means to the received historical cost data, with the weighting optimisation means utilising an algorithm which has the effect of weighting the most recent data more heavily.

The computer system may further include data capture means configured to capture cost data associated with a current service provided by a service provider, and updating means adapted to update said first data set to include said cost data associated with the current service provided by a service provider.

Typically, the historical cost data includes a plurality of associated service components and associated historical cost component data; and the processor is configured to generate comparative cost data in respect of each service component for each service provider.

Conveniently, the data storage means is configured to store a second dataset including a plurality of service providers, a plurality of associated services and a plurality of associated historical quality data, and said processor means is configured to additionally receive historical quality data associated with each service provider and generate comparative quality data for each service provider according to a predetermined algorithm; and said communication means is arranged to communicate said comparative quality data to the buyer to enable the buyer to select a service provider.

The comparative quality data may comprise a comparable quality index which can be processed with the comparable cost data to yield a comparable desirability index, typically by a process of normalisation.

The database may be further configured to store historical service enquiry data associated with the historical cost data, and wherein the processor executes instructions to retrieve and process said historical cost data in conjunction with said related service enquiry data to arrive at said comparable cost data.

The data capture component can be configured to capture service enquiry data associated with the captured cost data, with the updating means being arranged to update the historical cost data on the database with said captured cost and service enquiry data.

The present invention is based on the insight that an efficient marketplace can be encouraged if suppliers of services and/or goods know that their future work-flow is determined by a systematic comparison of their historical costs and historical quality. Thus the present system and method encourages sellers of goods and/or services to provide a high quality of products and services at competitive rates in order to increase their likelihood of obtaining business in the future.

In the specification and claims the term “services” should be understood to extend to services that include the provision of associated goods or spare parts as a sub-component of the service.

It will be understood that the invention disclosed and defined herein extends to all alternative combinations of two or more of the individual features mentioned or evident from the text or drawings. All of these different combinations constitute various alternative aspects of the invention.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows a flow-chart illustrating a method according to a first embodiment of the present invention;

FIG. 2 shows a portion of the historical cost data used for the production of the spreadsheet shown in FIG. 3;

FIG. 3 shows a spreadsheet configured to calculate comparable cost effectiveness rankings of service providers according to the first embodiment;

FIG. 4 shows a sample database of historical data request for surveillance investigations for a hypothetical buyer in connection with a second embodiment of the present invention;

FIG. 5 shows a spreadsheet of a mean historical responses for three sellers for each question tabulated in the database of FIG. 4; and

FIG. 6 shows an exemplary system for assisting a buyer to select a service provider; and

FIGS. 7A to 7E show a schematic representation of a relational database used in connection with a preferred embodiment of the present invention.

### DETAILED DESCRIPTION OF THE EMBODIMENTS

In broad Concept the present invention provides a system which can be used by an individual or organisation wishing to select a supplier from a group of suppliers to perform a service, with or without the provision of associated goods. The preferred embodiment of the present invention provides a method and system for achieving an efficient marketplace between a group of sellers and at least one buyer, where the buyer or buyers repeatedly purchase products or services from the sellers. The preferred embodiment may advantageously be applied to situations where a high number of transactions between the buyer and the sellers occur, thus providing a large amount of historical data on which to base predictions of future cost, quality, timeliness or other desired performance criteria. However the present invention should not be construed to be limited to a market of this type.

Preferably in using the system and method as described the service providers are aware that the attributes of their services (in particular price) will be compared with those of other service providers, thereby fostering competition within the marketplace. Accordingly the system and method described may provide means for trading in services of relatively low value which has the benefits of a tender system without requiring service providers to tender on a job-by-job basis.

In the present embodiment the system is particularly suited for selecting services and/or goods supplied with an associated service, which can be readily broken down into a number of identifiable and comparable service components or elements. Typically service elements will be tasks or features of the service for which service providers can allocate a discrete fee, and which the procurer of the service can readily use to define the scope or quality of the service desired.

The first step in using the system according to this embodiment is initialisation. The initialisation process begins by defining the elements of the service and a set of performance criteria which describe them. The service performance criteria can be used by a service user to describe a job they need performed, and by the service provider to describe attributes of the services which they perform.

The performance criteria describing the services can include attributes relating, inter alia, to:
the nature of the services;
specific attributes of the services; and
the cost of the service, or the cost of specific readily identifiable elements or components of the service;
the quality or type of equipment and/or resources required to perform a service;
the qualifications or association memberships desired by people performing a service;
other attributes of the service provider performing the job, which can affect the kind, quality or style of service performed, such as the length of time the supplier has been in business etc; and
historical information relating to the performance of past services which may be indicative of the level of service provided, such as the percentage of past jobs completed within a set deadline, and the satisfaction of previous service users with the service offered.

As described above, the system and method of the preferred embodiment of PCT/AU01/00660 primarily uses the current rates charged by each service provider to estimate a cost effectiveness ranking for each service provider, taking certain of the above performance criteria into consideration, and allows the buyer to select a service provider based on this information.

The inventors of the present invention have surprisingly discovered that accurate and robust estimates of expected costs can be derived by effectively ignoring the current or quoted rates charged for services and/or associated goods by sellers. The present embodiment accordingly uses historical cost data, which represent the actual amounts invoiced for a group of previous transactions and the description of the services and/or goods requested or supplied in each of the previous transactions to estimate and to drive future costs for similar or identical services. The provision of services can clearly include the provision of associated goods and disbursements.

By making the selection process known to the supplier, the supplier is encouraged to charge each customer as competitively as possible in the knowledge that their current invoicing directly affects their future work-flow. For the purchasers a marketplace operating on this principle is preferable as it encourages competition and lowers prices. Furthermore the present system is clearly preferable to receiving tenders or quotes, which are time consuming to prepare and to review and are susceptible to manipulation by suppliers.

An embodiment of the present invention will now be described in the context of the provision of insurance investigation services, more particularly in the context of the provision of 20 hours of surveillance of an insurance claimant. As will be appreciated by those skilled in the art the present invention is not limited to the provision of investigation services, but may be applied to the supply of services without limit. The services may or may not include a travel or delivery component.

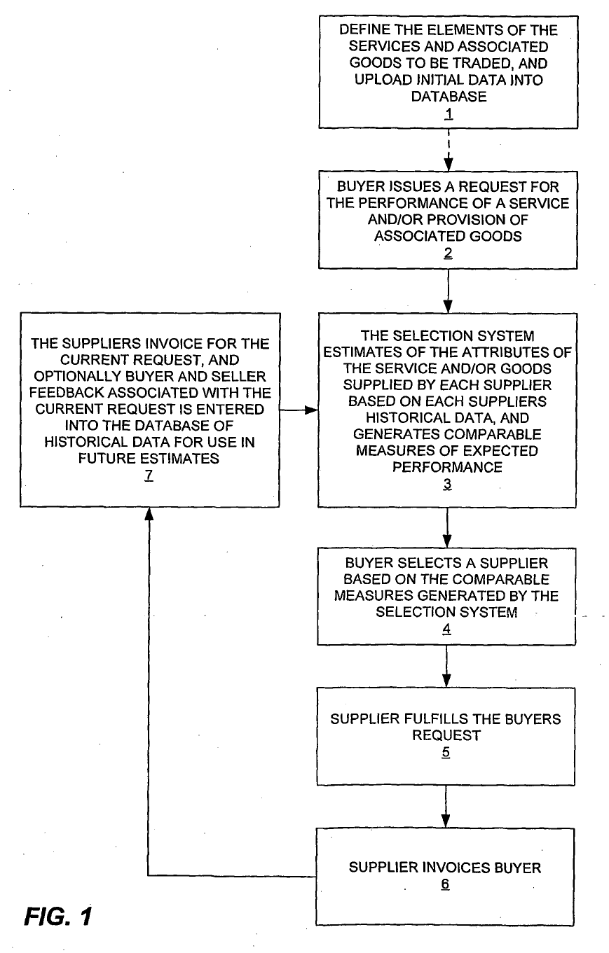

FIG. 1 outlines the steps in the present embodiment. As described above, in order to perform the method, the services and/or associated goods being traded in the marketplace must be defined. This is done in step 1 of the flow-chart.

The services and/or associated goods are defined by a set of elements that make up the services and/or associated goods and optionally a set of qualitative performance attributes. The elements of the services and/or associated goods can be used by a buyer to describe a product or service they need. Each of the sellers or service providers in the marketplace are required to split their invoices for each job into their charges for each element, to enable historical data to be readily assimilated and ultimately compared for each seller.

The qualitative performance attributes describe factors other than price which can affect the quality or kind of services and/or associated goods supplied by each seller, such as the quality or type of equipment and/or resources used to perform a service, or the qualifications or association memberships possessed by people performing the service. Historical quality or timeliness measures, such as the percentage of past jobs completed within a set deadline; and the level of satisfaction of previous service users with the supplier can also be used as qualitative performance attributes.

In the present example, where the service requested is an investigation service, two elements are used. The first element is travel, and the second element is an hourly rate for performing surveillance.

Once the services and/or associated goods being traded are defined in terms of their elements, the buyer can place a request for services and/or associated goods, in step 2. The buyer's request is set out in terms of the quantity of each element which they desire. The buyer can also specify relative weightings for each of the qualitative performance criteria if they wish to be presented with a comparable quality estimate for each of the service providers.

Optionally an importance weighting can be given to cost and quality criteria to allow the buyer to compare criteria of different types to one another. For example, if quality is twice as important to a buyer as price, then a final comparable desirability index can be generated in which the cost rating and quality ratings are weighted such that two-thirds of the final comparable indices for each seller are made up from a quality rating and one third from a cost-effectiveness rating.

Alternatively the comparable desirability index can be generated by using the quality rating as a multiplier which scales the comparable cost data. For example, each supplier's quality rating can be scaled into a multiplier between 1 and 1.5, with 1 being the highest quality and 1.5 the lowest quality. The remaining suppliers' quality multipliers can be scaled proportionally between these endpoints. The desirability index can then be calculated by multiplying the comparable cost estimate by the quality multiplier to generate a desirability index. Clearly the lower the desirability rating the more desirable the service provider is.

In step 3 the market-place software provides the buyer with a rating for each seller, reflecting their ability to fulfil the request. Typically this will be a cost effectiveness rating which is normalised to 1. A rating of “1” means a seller is of average price for the job, and a rating of 1.5 means that the seller is 50% more expensive than average. As will be appreciated by those skilled in the art other methods of presenting results enabling buyers to compare the relative cost and/or quality of the service providers can be used. For example, rather than normalising the cost estimates such that the average supplier is given a value of 1, the lowest cost supplier can be given a rating of 1, with more expensive suppliers being rated grater than 1 eg. 1.1 can be given to a supplier who is 10% more expensive than the cheapest supplier.

As described above it has been discovered that accurate and robust cost effectiveness ratings can be based primarily, or solely, on historical data extracted from previous invoices issued by a seller.

A normalised quality rating based on the qualitative performance attributes such as service quality, or timeliness, can also be derived from historical data, that reflects, inter alia, the satisfaction level of customers previously dealt with by the seller. The cost and quality ratings can then be combined according to the buyer's weightings, if it is desired to determine a final comparable rating for each seller.

In step 4 the buyer selects a seller, and in step 5 the seller supplies the services and/or associated goods requested to the buyer. The seller then, in step 6, invoices the buyer in a predetermined format for the supply of the services and/or associated goods.

Finally, in step 7, the seller's invoiced amount for the current request is added to the data set of historical data which can be used in for future predictions. The buyer can also rate one or more of the seller's qualities in performing the job, such as timeliness, for addition to the historical quality data set.

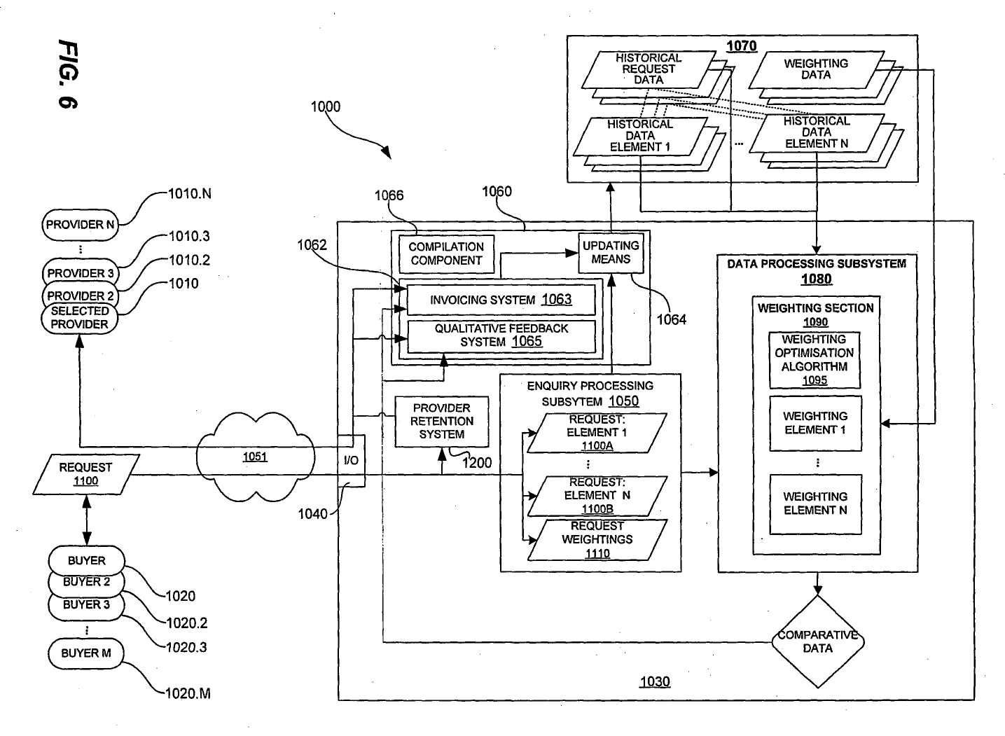

FIG. 6 shows an exemplary system for implementing the present invention. The system 1000 includes one or more service providers such as service provider 1010 and service providers 1010.2 to 1010.N and one or more buyers 1020 to 1020.M connected to the selection system 1030 via a communications network 1051. The selection system 1030 is connected to the communication network by an input/output port or other communications means 1040. The selection system 1030 includes four main subsystems, namely:
an enquiry processing subsystem 1050;
a data capture and invoicing subsystem 1060;
a database 1070; and
a data processing subsystem 1080.

The enquiry processing subsystem 1050 is adapted to receive a job request from a buyer, and to pass the request to the data processing subsystem 1080 in a form suitable for further processing. The enquiry processing subsystem 1050 splits an incoming request eg request 1100 into its request components or elements 1100A and 1100B. If the buyer has additionally specified weightings, ranking the importance of each of the elements of the request the enquiry processing subsystem 1050 extracts the weightings 1110 from the request 1100 and sends them to the weighting section 1090 of the processor subsystem 1080. In an alternative embodiment the request weightings 1110 can be forwarded to the data processing subsystem 1080 and grouped with their corresponding request element data eg 1100A or 1100B. The enquiry processing subsystem also passes request data, which is to be stored in the database 1070 as historical data, to the updating means 1064.

Upon receipt of a service request 1100 from the enquiry processing subsystem 1050 which is split into its elements 1100A and 1100B, the processing subsystem 1080 interrogates database 1070 to extract historical data relating to each element 1100A and 1100B of the service request 1100. The data processing subsystem 1080 uses the retrieved historical information relating to each request element, for all prospective service providers, to generate a comparable performance ranking for each of the service providers. The comparable performance ranking for each service provider is then sent to the buyer via the communications network to allow the buyer to select a service provider.

The data processing subsystem 1180 includes the weighting section 1090 which allows weightings to be extracted and applied during the calculation of the comparable performance data. Firstly, the relative importance of each element of a request may be weighted in accordance with request weightings 1110 included in the buyer's request 1100. Alternatively, a predetermined weighting scheme can be set up for each buyer and stored either in the weighting section to allow a predetermined weighting routine to be used for all job requests issued by a particular buyer. Weightings can also be applied by the weighting section 1090 to the historical data received from database, for example so that more account is taken of the most recent historical data, and less cognisance is taken of older historical data, when generating the comparative data with the data processing subsystem 1080. The weighting section 1090 can also include a weighting optimisation algorithm 1095 having weighting variables which can be used to optimise the weightings given to the historical data when calculating the comparable performance data. If it is determined that the historical data relating to the five most recent jobs performed by each service provider is to be used by the data processing subsystem 1080 to calculate the comparative data, the weighting optimisation algorithm 1095 can be used to impose this condition on the calculations of the processing subsystem 1080. The weighting optimisation algorithm can also utilise feedback from the selected service provider 1010, which is received by the data capture means to generate optimal weightings for historical data. A process for optimising weightings is described below.

When the comparative data is generated in the data processing subsystem 1080 the data is communicated by the communication means 1040 and the communications network 1051 to the buyer. The buyer can then select a service provider to perform the job. The process of retaining the selected service provider to perform a job is performed by the provider retention system 1200. The provider retention system 1200 is configured to receive a retention confirmation from the buyer indicating the buyer's selected service provider. The provider retention system 1200 then generates and sends a work order, and an email confirmation to the selected provider, indicating that he or she has been selected to perform the buyer's requested job.

Once the service has been performed the selected provider 1010 will issue an invoice to the buyer 1020. In this embodiment the invoice is generated by the invoicing system 1063 of the data capture and invoicing subsystem 1060. The selected provider indicates to the system the amounts to be charged to the buyer for each element of the job performed, by answering a series of invoicing questions. This generates an invoice in an agreed format, including appropriate breakdowns for rates, times, distances and the like that correspond with the various request elements. In the preferred embodiment the service provider's invoice is transmitted to the buyer 1020 via the invoicing system 1063. The invoicing system 1063 also sends the service providers answers to the invoicing questions relating to the cost charged for each element of the service to the answers table 1707 of the database 1070 via the updating port 1064.

Thus the system may be viewed as including an automatic feedback system whereby every time a service provider performs a job the service provider's invoice for that job is broken down into a cost for each requested element and this information is stored in the database 1070. This feature of automatic updating of the database in combination with the use of weightings allows the system to emphasise the most recently performed jobs in a predetermined way (using the weightings optimisation algorithm 1095), such that the most recent invoice, or a weighted combination of the most recent invoices issued by each service provider will be effectively become a tender for the next requested job.

The data capture and invoicing subsystem 1060 also includes a qualitative feedback system 1065 which allows both the buyer 1020 and selected provider 1010 to input data relating to the quality of the service provided. The qualitative feedback system 1065 gathers data from both the buyer 1020 and selected provider 1010 relating to the qualitative aspects of the service being provided. For example the service provider 1010 can be asked to specify the time at which the job was begun and when it was completed and such data can then be used to rank the timeliness of the service provider for future jobs. The buyer 1020 can be asked to rate the quality of the service provided according to a variety of qualitative criteria of the type described further on in the specification. The qualitative data thus collected by the qualitative feedback system 1065 is stored as an answer 1707 to its associated question 1708 in the database 1070, via the updating means 1064.

As mentioned above, prior to using the selection system, it must be initialised by the compilation of a database of historical cost and quality information. This is performed by the compilation component 1066. The compilation component 1066 effectively allows a series of data to be uploaded into the database via the updating port 1064.

As will be appreciated by those skilled in the art, the various subsystems may be embodied either as hardware or software components of the system. For example, a dedicated processor could be used for each of the data capture, enquiry processing subsystem 1050, and data processing subsystems 1090, or alternatively a single micro-processor may be used to perform each function of these subsystems with the function of each subsystem being defined in various sub-routines of the a software package running on that micro-processor.

In the preferred embodiment the communications network 1051 is the internet. However, the communications network can, in general, be any type of wireless or wired computer network that allows the service providers and buyers to exchange data with the selection system 1030. In large organisations which have a number of users (buyers) it may be convenient to have an in-house selection system, in which case the buyers' terminals and selection system will be located as part of the company intranet or LAN, and the selected service providers may be connected to it by the Internet, WAN, or other external network.

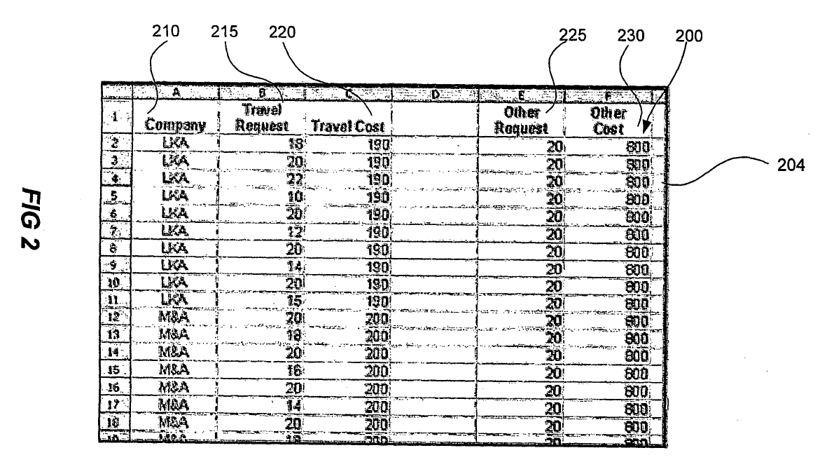

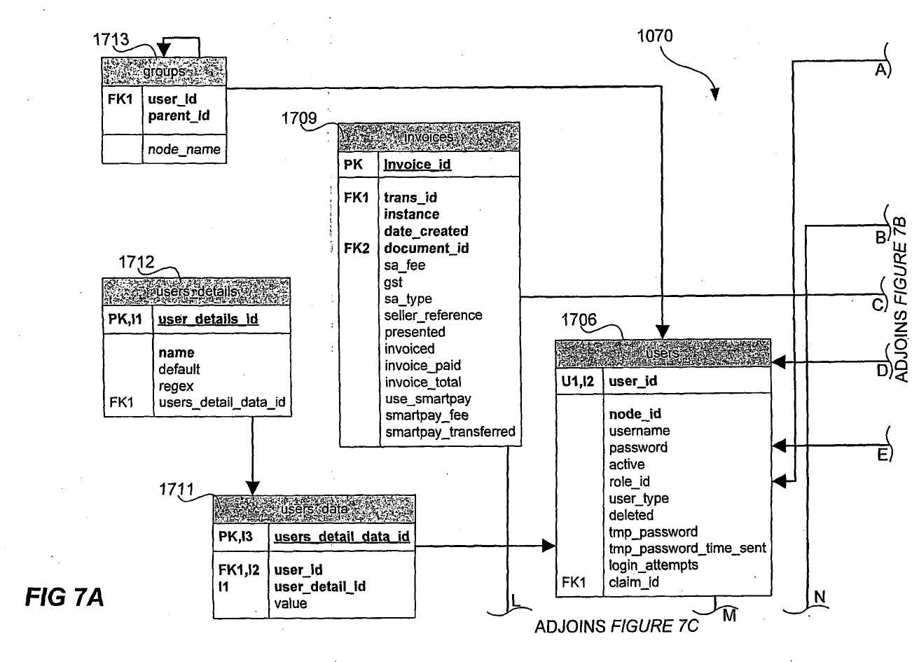

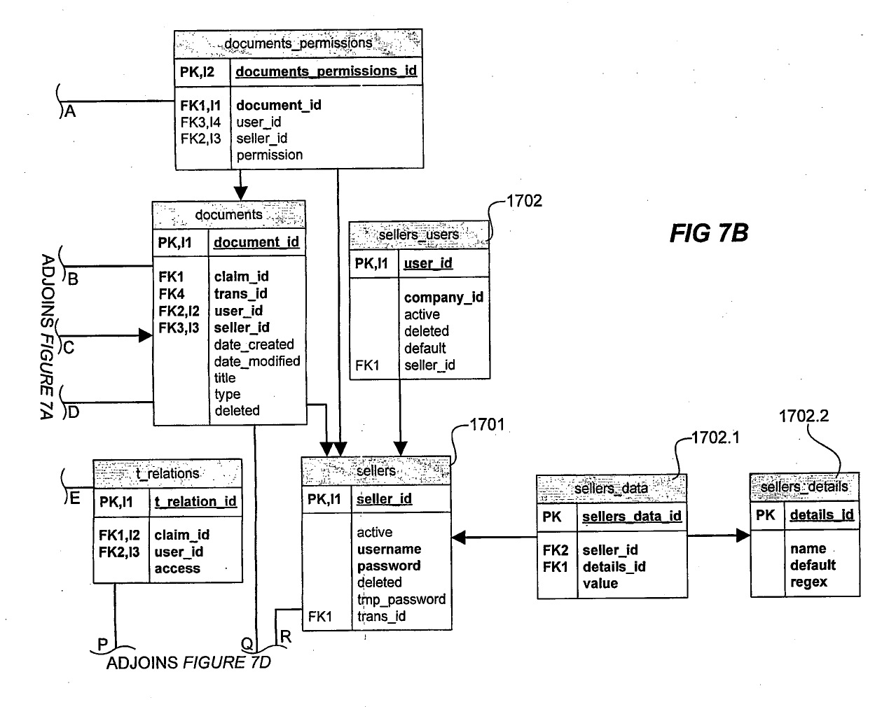

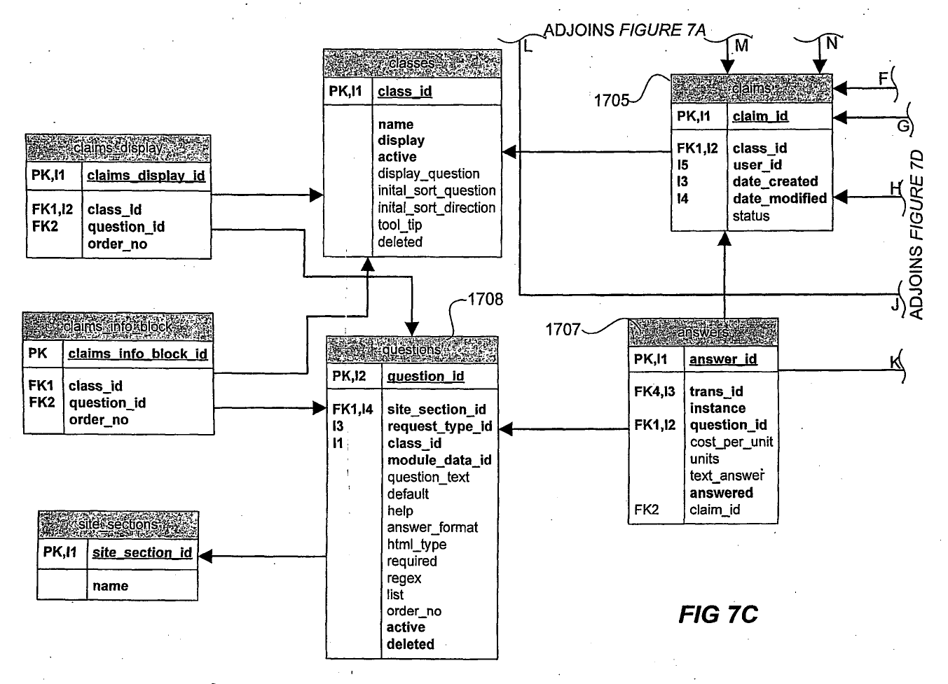

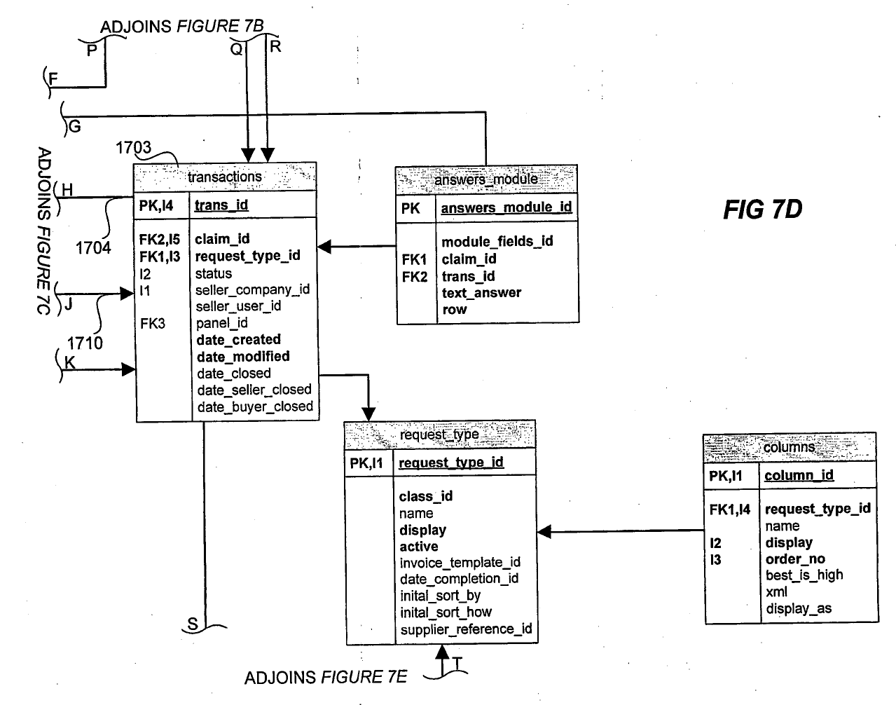

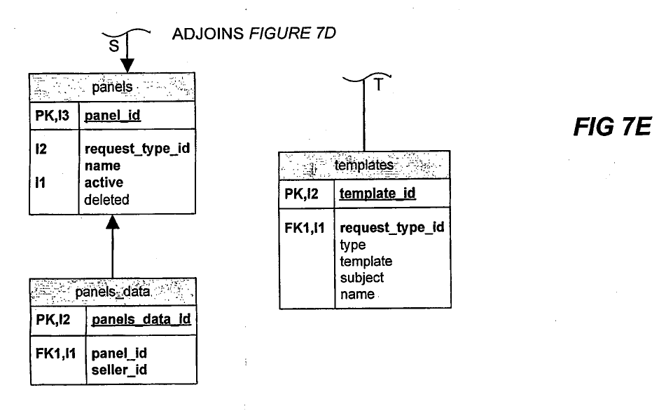

FIG. 2 shows part of a data set 200 containing historical data for two of three investigation companies. The data represents data extracted from the database of FIGS. 7A to 7E. Each row 204 represents one job requested by a buyer, and performed by the company, with the most recent request appearing first. The data contained in each of the rows 204 can alternatively be viewed as invoices rendered by the seller.

The first column 210 of the data set designates the company issuing the invoice, and is extracted from the sellers table 1701 of database 1070, and the second column 215 represents the distance travelled by the company when performing an investigation this data is stored as an answer to a question in table 1707 of database 1070. The distance travelled in each case not be equal to the distance invoiced by the service provider for the job, rather it is calculated by the marketplace software. The distance is determined by calculating the distance between the service provider nearest operating location and the location at which the surveillance job is performed. Thus in essence this is a theoretical distance requested by the buyer and may not represent the actual distance travelled by the service provider in performing the job. The next column 220 contains the amount, in dollars, charged by the service provider for the travel performed in each job this data is also stored as an answer to a question in table 1707 of database 1070. In this case the answer is the answer to a question asked of the supplier when an invoice is generated. Column 225 contains the number of units of surveillance requested by the buyer in each job, as with column 215 this data is stored as an answer to a question in table 1707 of database 1070. Again, this number is not representative of the number of hours billed by the company in each job but is the actual number of hours requested by the buyer. Final column 230 contains the actual amount charged by the company for performing surveillance in each job. This data is an answer provided by the supplier when creating an invoice and is stored in the answers table 1707 of database 1070. If additional services are requested by the buyer, additional columns of information may be contained in the data set. For example, if a cost is charged for writing a report, or providing photographs to the buyer, or administrative charges are levied then the invoice can be broken down into additional elements, and data collected for each of these extra components. Again these additional service components would be represented as one column representing the number of units of each additional service requested by the buyer and the total charged for the item in each particular job. Alternatively the administrative or photographic costs can be added into the surveillance costs to provide a consolidated element.

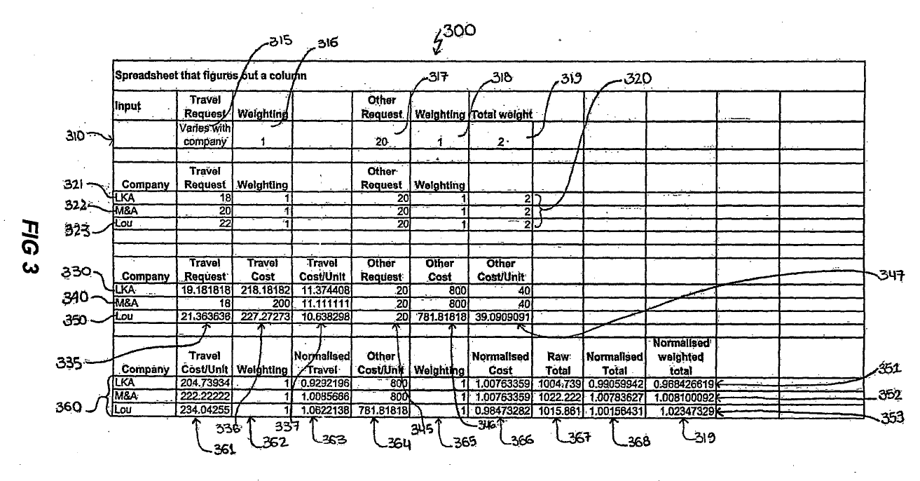

FIG. 3 shows the results of the various calculations performed by the marketplace software. The first row of the spreadsheet 300 sets out the request input into the system by the buyer. In this case the request is for 20 hours of surveillance performed at a particular location. This is represented in row 310 by the travel request in cell 315. The travel request is of variable length depending on which company is engaged as shown in cell 315. Cell 317 represents a request for 20 units (each unit being an hour) of surveillance. Each component of the service can be weighted to reflect the importance of it to the buyer. As all of the values in this request are monetary values and cost effectiveness is the desired suitability measure the travel cost is weighted equally with the surveillance cost. This is represented by the value 1 being placed in cells 316 and 318. Cell 319 represents the aggregate value of all of the weightings of the components on the service requested by the buyer.

The service request in spreadsheet 300 is also displayed in a form which includes the travel distance required for each of the service providers. In this instance the three service providers, LKA, M&A, and Lou (321, 322 and 323 respectively) each have to travel a different distance to perform the job. It can be seen that by looking at the values in row 321 LKA must travel 18 km to perform the job, M&A must travel 20 km (cell 322), and Lou must travel 22 km (cell 322). The other values contained in rows do not vary between the service providers, and are thus identical to that shown in the request row 310.

Rows 330, 340 and 350 of the spreadsheet 300 show a series of calculated values representing the costs historically charged by each of the service providers for the performance of surveillance jobs in the past. For each of the service providers the value contained in column 335 represents the average travel distance requested in past jobs. The value in column 336 represents the average travel cost which each service provider has invoiced in the past. These values are derived from the actual values invoiced by the service provider. The values in column 337 are derived by dividing the average invoiced travel cost by the average requested travel distance for each service provider, to determine an average travel cost per requested kilometre of travel. It can be seen that in the past LKA on average has been requested to travel 19.18 km for each job which they have performed and on average has invoiced their client $218.18 for travel giving an average cost per requested kilometre of $11.37. From row 340 can be seen that M&A's average travel request is 18 km and their average travel cost is $200 giving rise to an average cost per requested kilometre of $11.11. Lou on average has been requested to travel 21.36 km per job and has charged $227.27 on average per invoice for the travel component in previous jobs. Thus Lou's average travel cost is $10.64 per requested kilometre of travel.

In the present embodiment the cost per unit for each component of the invoice is calculated from the amounts invoiced on previous jobs, and the number of units requested by the buyer in previous jobs. This is distinct from using the number of units of service delivered by the service provider. Thus, service providers who habitually over-service, by providing more units of a particular good or service than requested, or who are inefficient and require additional time or travel to perform a job, are shown up by the system as being more expensive since the number of units for which they issue an invoice is greater than the requested number of units. This ability to take into account and to compare the variable work practices of goods and service providers when determining their average historical cost also provides advantages for more efficient or cheaper goods and service providers. An example of this can readily be seen in terms of the travel component of a job. If a service provider can perform the service with less than the predicted travel distance and does not “premium” their travel expenses to bring them into line with expectations, their average cost per unit of requested travel will decrease.

In alternative embodiments, particularly in industries where over-servicing is not a common problem or services tend to be provided on an on-going basis, ie service requests are not made for a fixed number of units, the number of units supplied may be used to determine the average cost per unit for a particular element of a service.

Columns 345, 346 and 347 of rows 330, 340 and 350 show calculations to determine the average cost per requested unit for surveillance tasks. This is performed in a similar fashion to the travel cost. Column 345 displays the average number of surveillance hours requested on previous jobs performed by LKA, M&A and Lou respectively. In this example each of the suppliers has on average been requested to perform 20 hours of surveillance per job in the past. Column 346 shows the average cost invoiced to their clients in respect of the previous jobs performed by each service provider. On average both LKA and M&A have charged an average of $800 for 20 hours of surveillance whereas Lou has charged an average of $781.09 for 20 hour surveillance in the past. Column 347 contains the average historical cost per unit of surveillance requested for each of the service providers. As can be seen by the value in row 350 in the past Lou has invoiced the lowest cost per requested unit of surveillance in the past.

As described as above in relation to travel cost, the cost per requested unit value derived for the surveillance component of this job reflects a comparison between the jobs requested in the past and the actual charges invoiced for these previous jobs. Thus if one of the service providers commonly suggested to their clients after 20 hours of requested surveillance was performed that an additional 10 hours of surveillance was needed to adequately complete the job and an additional amount was invoiced for these hours over and above the initial request this would be reflected as an increased cost per requested unit, rather than as an increase in the number of hours requested in a previous job.

In the present example the calculation of the cost per unit of requested services and/or associated goods has been calculated by averaging the invoiced cost for the most recent jobs performed by each service provider. However, other statistical methods and analysis can be performed to accurately predict for the invoiced cost per unit requested. For example, a weighted average of the value over the previous ten (or any desired sample size) jobs may be used for each service provider. The largest weighting can be given to the most recent job, with the weighting tapering off to the lowest weighting for the oldest job. By using a weighting system such as this, service providers are encouraged to think carefully when issuing each bill as they know that their most recent bill is the most important factor in them securing their next job.

The number of past jobs which are included in the data set may also be varied to tailor the system to a particular application. For example, in some industries where price fluctuates quickly it may be necessary to only use a small sample of past jobs for determining cost effectiveness. Furthermore, a different statistical value can be used rather than the average such as the median or geometric mean. Certain jobs or sales may even be removed from the sample set used, say the two most expensive and two least expensive jobs, or all jobs falling outside two standard deviations from the average.

In a particularly preferred embodiment, after each job is fulfilled and the invoiced cost recorded, ie. the invoiced cost is added to the historical dataset, an optimisation routine can be used to calculate the weighting for historical data which would have resulted in the best cost estimate of the newly received invoice. This optimised weighting scheme can then be used to weight the updated historical data to estimate the cost effectiveness of the service providers in respect of the subsequent job requests.

The last group of rows 360 in spreadsheet 300 shows the final cost effectiveness calculations and predictions made by the marketplace software. Rows 351, 352 and 353 show the calculated values for LKA, M&A and Lou respectively. The first column of values shows an estimated travel cost for each of the companies for the performance of the current requested job. This is derived by multiplying the cost per requested unit of travel contained in column 337 by the distance which must be travelled by the company to fulfil the request made by the buyer. Thus, to derive the entry for LKA in column 361, 11.37 is multiplied by 18 to arrive at 204.74. Similar calculations are made for M&A and Lou.

In order to allow the travel costings to be compared to other cost effectiveness or qualitative performance criteria a normalised travel cost is derived. The normalised travel costs are derived by dividing the travel cost for each company by the average travel cost for all of the companies. Normalised travel costs for each of the three companies are shown in column 363. A company which has a travel cost equal to the average will end up with a normalised travel value of 1, whereas a company who is expected to charge 10% above average for this job will receive normalised travel value of 1.1. By performing this calculation it can be seen that M&A's normalised travel value is derived by dividing 222.22 by (204.74+222.22+234.04/3)=1.01.

An identical process is performed for estimating the surveillance cost for each service provider in columns 364 to 366. In this regard, the values of column 364 are derived by multiplying each company's average cost per surveillance unit (which is shown in column 347) by the number of surveillance units requested. It can be seen that both LKA and M&A are expected to charge $800 for the surveillance component whereas Lou is expected to charge $781.82. The weighting column 365 is also displayed for the surveillance component of the invoice.

Column 366 shows a normalised cost calculation for the surveillance component of the present job for each company. Again, this is calculated for each company by dividing the estimated cost of each company by the average estimated cost for all of the companies. It can be seen in this example that LKA and M&A are slightly above average cost, whereas Lou is slightly below average cost at 0.98 normalised surveillance value.

The next column 367 shows a total estimated cost for each of the service providers. This is simply calculated by adding the calculated travel cost to the calculated surveillance cost. A normalised total cost is also produced by the marketplace software and entered into the cells of column 368. The normalised total cost for each company is produced by dividing each company's total cost by the average total cost of all of the companies. Thus it can be seen that LKA is predicted to be the most cost effective with a predicted cost effectiveness of 1% lower than average, Lou is expected to be of average cost, having a normalised cost effectiveness value of 1 and M&A is expected to be 1% more expensive than the average service provider for performing this job. The last column on this spreadsheet shows a normalised weighted total value for each service provider. The normalised weighted total shown in column 369 for each service provider is derived by performing a weighted sum of the normalised values of each of the components of the service invoice or other assessment criteria. In this particular example as travel cost and surveillance cost of the invoice are both in dollars, they have equal importance and are both weighted as 1 (as shown in cells 316 and 318 of the spreadsheet 300). Thus for each company the normalised travel value is added to the normalised cost value and divided by 2, being the total value of the weightings. Thus it can be seen that LKA's normalised weighted total is 0.97, M&A's normalised weighted total is 1.01 and Lou's normalised weighted total is 1.02.

The present embodiment also allows the job allocation practices of different buyers using the system to be compared. To do so it is advantageous to use a variation on the previously described normalisation process. If one person allocating jobs to service providers uses only a small subset of the possible service providers, for example because of geographical limitations or differences in supplier capabilities, the spread of cost estimates can be relatively small, for example, $900 for the cheapest supplier and $1000 for the most expensive. In comparison, a system with users able to select suppliers from a large pool of suppliers has a better chance of having supplier with a wider range of historical costs, for example the cheapest estimate for a particular job may be as low $700 and the most expensive at $1300. The average cost of each of all suppliers for these jobs may both be $1000, but the buyer with the narrow supplier choice would show that they selected the supplier rated at 0.9 ($900/$1000), while the buyer with the larger supplier choice would select the supplier at 0.7 ($700/$1000). A manager comparing the buyers would instinctively think that the later buyer is doing a better job of selecting suppliers.

Thus, instead of comparing suppliers against the average cost supplier, the normalisation can be made against the most cost effective supplier. In this example each of the buyers would show up as having selected the supplier rated “1” eg. $7.00/$700=1 and $900/$900=1. Thus, each buyer has identified and selected the cheapest supplier, but using the former normalisation technique it is not readily possible to compare the decision-making process of the buyers.

Once the buyer selects a supplier and the supplier fulfils the service request, the invoice from the buyer, which is preferably split into the defined service elements, can be added to the historical dataset. In a preferred embodiment the addition of invoices to the dataset is automated. In a particularly preferred embodiment the marketplace software is integrated with the billing and payment systems of both the buyers and sellers enabling invoices to be issued and historical cost data to be recorded automatically.

A third embodiment of the present invention will now be described, again in the context of the provision of surveillance investigation services. This embodiment of the present invention provides the user with relative cost estimation for each of the potential sellers based on historical costs, and also provides a number of quality related comparable performance criteria which the potential service user may use to pick the most desirable seller.

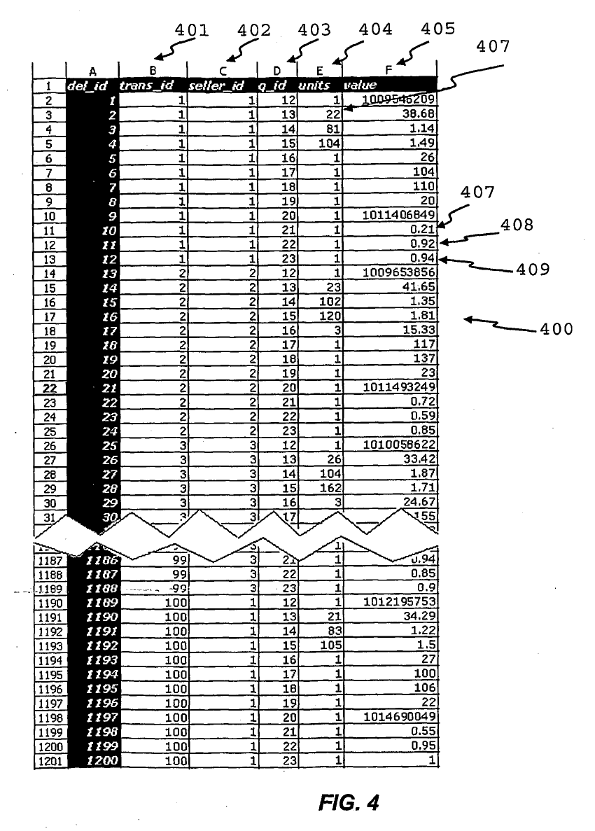

Referring first to FIG. 4, part of a typical set of data extracted from the database 1070 relating to a number of historical requests for surveillance investigations provided by three sellers for a hypothetical buyer is shown. The data is set out in spreadsheet form, and includes a transaction identification column 401 (from table 1703 of database 1070) listing 100 sales transactions, a seller identification column 402 (from table 1701 of database 1070) identifying the seller associate particular transaction, a question identification column 403 (from table 1708 of database 1070), a number of units column 404 (from answers table 1707 of database 1070) and a value per unit column 405 (also from an answers table 1707 of database 1070).

In order to perform the historical cost and quality analysis properly, calculation of the historical costs of the group of three sellers must be performed. In the case of a surveillance investigation, this is achieved by breaking down each investigation, into elements e.g. on a cost per unit of time and distance basis. Each of the historical investigations is accordingly divided into a number of “questions” the answers to which are stored as answers (table 1707 of database 1070). Typical examples of such questions are listed below:

TABLE 1
Historical Questions

| | |
|---|---|
| Q12 | When was the investigation requested? |
| Q13 | Cost per hour of surveillance performed? |
| Q14 | Cost per kilometre travelled? |
| Q15 | Cost per hour of travelling? |
| Q16 | Cost of video tapes recorded? |
| Q17 | Administration costs? |
| Q18 | Other costs? |
| Q19 | Minutes of useful video tape recorded? |
| Q20 | Date investigation completed? |
| Q21 | % of successful observations on videotape |
| Q22 | % of elements of investigation completed satisfactorily |
| Q23 | Comprehensiveness of report, as a % |

The question numbers are filled out in the question identification column 403. For example, as is shown at 406, Q13 corresponds to 22 units and has a value of 38.6. Question 13 deals with the cost per hour of surveillance conducted on the particular job. In this case, the particular investigator of seller 1 performed 22 hours of surveillance and charged $38.60 per hour of surveillance, for a total cost of $851. Questions 14 and 15 also relate to costs per unit (hours and kilometres respectively), with the units column 404 detailing the actual number of kilometres and hours travelled. Questions 16-18 refer to other sundry costs, and questions 12 and 20 relate to the respective commencement and completion dates of the investigation. The data values given as answers to questions 12 and 20 are given in Unix time, namely in seconds elapsed as from 1 Jan. 1972.

The answers to quality assessment questions 21-23 have been normalised from percentages. By way of example, a value of 0.21 is provided at 407, which corresponds to a figure of 21% of successful observations being made on videotape in respect of the first transaction by seller 1. In the following question 22 shown at 408, the score of 0.92 corresponds to 92% of the investigation being completed satisfactorily, and at 409 the Figure 0.94 indicates that the score of 94% was given to the comprehensiveness level of the report. It will be understood that, for ease of reference, the quality answers may be given upper and lower limits which are ultimately normalised. A permissible answer range may also be provided. In its most basic form, the answer range may include “yes” and “no” answers which are allocated a “one” and a “zero” respectively for converting multiple choice-type answers, intervening answers such as “sometimes”, “half the time” and “most of the time” may be “normalised” to equal, say, 0.25, 0.5 and 0.75 respectively. All of the quality questions are answered and entered on the buyer's side, with guidelines being provided to maintain a level of objectivity.

All of the historical cost data provided in the table of FIG. 4 is derived from sellers' historical invoices typically furnished by the buyers. The invoices are formatted and broken down in such a way that the data providing “answers” to the questions can be readily extracted. Ideally, there is a direct correlation between the questions and the per unit cost and number of units presented in the invoices.

The data from each seller may be calculated according to various historical calculation formulae. The simplest formula is to take the mean average for each seller in respect of each question. A more sophisticated formula is to take the mean of, say, the past ten jobs for each seller. An even more sophisticated formula would be to calculate the average price for the past hundred jobs on a sliding exponential scale where the more recent jobs are weighted more heavily than the earlier jobs. One of the main driving factors is to ensure (and make it known to the sellers) that there is a direct correlation between recent invoicing pattern and work awarded.

Table 2 below sets out questions 8-12 which are stored as a question in questions table 1708 of database 1070, which form part of the initial request put out by the buyer. Questions 8 and 9 are calculated using a separate software module which calculates the optimum times and distances between the various investigators and the investigation sites. The travel module takes the origin suburb(s) and the destination suburb(s) and return the shortest distance each seller would have to travel as described above.

TABLE 2
Request Questions

| | |
|---|---|
| Q8 | How many kilometres will the investigator travel? |
| Q9 | How long will the travel take? |
| Q10 | How many hours of surveillance would you like conducted? |
| Q11 | When are the instructions to be received? |

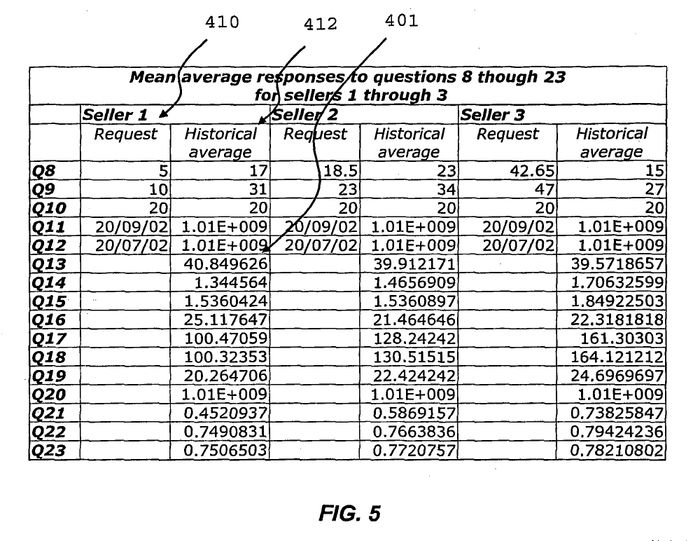

Referring now to FIG. 5, a table of the mean responses of three sellers in respect of each question is shown. The request column 410 in respect of seller one shows, at questions 8-10 respectively, the kilometres the investigator will travel (5), the travel time (10), and the respective hours of surveillance requested (20).

The historical average column 412 provides the historical averages for seller 1 in respect to questions 8-10 as calculated using the historical calculation formula. In the case of seller 1, the historical average kilometres travelled is given as 17. This is calculated by extracting from the units column 404 in FIG. 4. The units (in this case kilometres) corresponding to question 14 and using the historical calculation formula to derive the “average” of 17. Similarly, the average travel time of 31 hours is extracted from the database of FIG. 4, as is the average investigation time of 20 hours. The respective completion and commencement dates are similarly averaged. The average historical cost per unit of surveillance delivered by seller one is shown at 414. Sorting the data in this historical average fashion makes the calculation of expected surveillance costs quite easy by simply multiplying the number of requested surveillance hours (20) by the average historical cost per unit of surveillance (40.85).

Significant advantages of the system and method of the invention are realised when the groups of similar questions are combined into columns using the various formulae such as those set out in Table 3 below.

TABLE 3
Algorithms for calculating each of the columns

| | |
|---|---|
| C1 | (Q8R * Q14H) + (Q9R * Q15H) + (Q10R * Q13H) + Q16 + Q17 + |
| | Q18 |
| C2 | ((Q21H * 3) + (Q22H * 2) + (Q23H * 1)) |
| C3 | Q20H − Q12H |
| C4 | 1 * ((C1/C1Ave) − 1) + ((C2/C2Ave) − 1) + −1 * ((C3/C3Ave) − 1) |

Column 1 indicates the expected cost for each seller for the particular job. The result is displayed as a dollar amount in Table 4 below for each seller. According to the formula, the column C1 displays the sum of the following five variables or combinations thereof: the requested kilometres in question 8 multiplied by the historical average cost per kilometre of question 14; the requested hours of travel of question 9 multiplied by the historical average cost per hour travelled of question 15; the requested hours of investigation of question 10 multiplied by the historical cost per hour of investigation of question 13; and the historical averages of questions 16-18.

TABLE 4
Column Calculation results

| | Seller 1 | Seller 2 | Seller 3 | Average | Stance |
|---|---|---|---|---|---|
| C1 | $1,064.99 | $1,140.91 | $1,298.87 | $1,168.26 | Goofy |
| C2 | 60.08% | 67.76% | 76.42% | 68.09% | Natural |
| C3 | 26.79 | 19.71 | 23.98 | 23.49 | Goofy |
| C4 | −0.17 | 0.18 | −0.01 | 0 | |

In column 2, each of the quality-related questions 21-23 is weighted by multiplying the question by a particular weighting factor. In the particular example, question 21 is heavily weighted by being multiplied by three, question 22 is moderately weighted by being multiplied by two, and question 21 is not weighted at all, and is thus multiplied by one, with the result being divided by six and displayed as a percentage. In column 3, the average is requested commencement date is subtracted from the average actual completion date of question 20 to get the average job duration in days.

When combining separate data types which represent different units, such as cost (currency) quality (percentage) and duration (days), each of the values needs to be normalised. The direction of normalisation depends on whether the most preferred value is the higher value, (as in the case of quality) or the lowest value (as is the case with cost). To combine cost and quality, the columns need to be normalised in different directions. For illustrative purposes, this is known as “stance”. When the best result for a column is the highest result (as is quality) this is known as “natural” stance, and when the best results are the lowest, (such as costs and duration) this is called left or “goofy” stance (using skating/surfing terminology).

Column C4 of Table 4 includes a formula which effectively normalises and then combines the respective cost, quality and duration factors of columns 1 to 3 to arrive at a figure which quantifies the relative desirability of each seller. In the particular calculation, cost, time taken to complete the job and the combination of the above mentioned quality factors have all been given equal weightings. Naturally, this can be altered by the buyer simply by using the selected multiplier on each of the normalised figures.

In the particular example, the formula of C4 has the effect of normalising each of the column calculations of C1-C3 around zero. It will be noted that C4 has been calculated to yield a “natural” result, in which the highest figure indicates the preferred seller. This is achieved by using a multiplier of −1 in the case of C1 and C3, both of which have a “goofy” stance.

Assuming that seller 2 is selected, seller 2 is then notified and commences the job in accordance with the laid down parameters. On completion of the job seller 2 submits an invoice in a broken down format as described above which readily allows it to be entered into the database 1070. This can be achieved automatically, with manual entry being confined to quality questions 21-23.

Database 1070 can be arranged in many ways, for example, database 1070 may be a relational database having data referenced by many variables eg, service elements, and service provider. Alternatively, a series of databases each pertaining to a possible service element or service provider may be used. Other configurations are also possible. An exemplary database structure which can be used in a system for selecting service providers to investigate insurance claims is shown in FIGS. 7A to 7E of the accompanying drawings. As will be appreciated the database 1070 is a relational database comprising a plurality of interrelated tables. Selected tables and the relationships between them will now be described.

Data relating to each user (or buyer) is stored in accordance with the “users” table 1706, the “users_data” table 1712, and the “users_details” table 1712. Groups of users are also defined in the “groups” table 1713. Data for each service provider includes the data stored in the “seller” table 1701, the “seller-users” table 1702, the “sellers_data” table 1702.1 and the “sellers-details” table 1702.2. For example details of each of a sellers employees is stored in the “seller_users” table 1702.

To generate a job request (create a new transaction) a series of questions from the questions table 1708 are answered by the buyer as described above. The answers to the questions define the requested service and are stored as answers in the answers table 1707. The “transactions” table 1703 stores data relating to each service request made. Each job or transaction is associated with an insurance claim (relationship 1704), an invoice and a user 1706 ie. the buyer who has requested the job. The system uses the claim number data stored in the “claims” table 1705 or transaction id stored in the “transactions” table 1703 to identify and track a job through the system. Transactions for which a service provider has been appointed has the selected service provider's data associated with it.

Invoicing works along the same lines as the creation of a transaction with the selected supplier being asked a number of questions 1708 relating to the attributes of the service they provided and cost of the service. The answers to the invoicing questions are stored in the answers table 1707, and associated with the transaction id. The answers stored in this way form the basis of the invoice. Data for tracking, inter alia, when invoices are generated and payed is stored in the “invoices” table 1709.

Quality (and timeliness data) relating to a job are also stored through a question and answer process. The buyer and seller are asked a series of questions stored as questions (1708) and their answers 1707 are stored. If quality ratings are requested by the buyer when requesting a job, these answers are extracted from the answers table of the database 1070 and used to calculate comparable quality data for each service provider.

As can be seen the database structure provides a set of historical cost and quality data relating to each claim or transaction for that is able to be referenced by service provider and used for calculating comparable performance data for each service provider for the next job requested.

The described method is thus implemented using an application which is typically in XML format. The data structure for a request is most naturally described using a schema and an XML document. Annexure A is a sample XML file showing a typical surveillance request. Annexure B is a schema which defines the valid request XML file. The contents and operation of this schema and the file of Annexure A will be clearly apparent to a normally skilled XML programmer.

It would be appreciated by a person skilled in the art that numerous variations and/or modifications may be made to the present invention as shown in the specific embodiments without departing from the spirit or scope of the invention as broadly described. For example, the present selection system for investigation services here described has been implemented on the Internet, but other networks configurations could also be used to implement the present invention. The present embodiments are therefore, to be considered in all respects to be illustrative and not restrictive.

Copyright Notice/Permission

A portion of the disclosure of this patent document, and in particular Annexures A and B, contain material which is subject to copyright protection. The copyright owner has no objection to the facsimile reproduction by anyone of the patent document as it appears in patent office records once publicly available, but otherwise reserves all copyright rights whatsoever. The following notice applies to the software and data as described and illustrated below: Copyright 2001, 2002, 2003, River Dynamics Pty Ltd., All rights reserved.

Annexure A

XML File: request.xml

The data structure for a request is most naturally described with a schema and xml document. The following is a sample XML file showing a surveillance request.

```
1.<?xml version=“1.0” encoding=“UTF-8”?>
2.<request transactionId=“1” requestorId=“269” xmlns=“http://www.smartalloc.net/XMLSchema”
    xmlns:xsi=“http://www.w3.org/2001/XMLSchema-instance”
    xsi:schemaLocation=“http://www.smartalloc.net/XMLSchema
3.request.xsd”>
4. <sellers>
5. <seller id=“1”>
6. <questions>
7. <module qid=“8” type=“travel” returnType=“distance” calcMethod=“oneToMany” calcOperation=“sum”>
8. <origins>
9. <origin>
10. <address>
11. <street/>
12. <city>Liverpool</city>
13. <state>NSW</state>
14. <country>AU</country>
15. </address>
16. </origin>
17. <origin>
18. <address>
19. <street/>
20. <city>Sydney</city>
21. <state>NSW</state>
22. <country>AU</country>
23. </address>
24. </origin>
25. </origins>
26. <destinations>
27. <destination>
28. <address>
29. <street/>
30. <city>Bondi</city>
31. <state>NSW</state>
32. <country>AU</country>
33. </address>
34. </destination>
35. </destinations>
36. </module>
37. <module qid=“9” type=“travel” returnType=“travelTime” calcMethod=“oneToMany”
    calcOperation=“sum”>
38. <origins>
39. <origin>
40. <address>
41. <street/>
42. <city>Liverpool</city>
43. <state>NSW</state>
44. <country>AU</country>
45. </address>
46. </origin>
47. <origin>
48. <address>
49. <street/>
50. <city>Sydney</city>
51. <state>NSW</state>
52. <country>AU</country>
53. </address>
54. </origin>
55. </origins>
56. <destinations>
57. <destination>
58. <address>
59. <street/>
60. <city>Bondi</city>
61. <state>NSW</state>
62. <country>AU</country>
63. </address>
64. </destination>
65. </destinations>
66. </module>
67. <q id=“10” type=“number”>20</q>
68. <q id=“11” type=“dateTime”>2002-09-20T00:00:00+10:00</q>
69. <q id=“12” type=“dateTime”>2002-07-20T00:00:00+10:00</q>
70. </questions>
71. </seller>
72. <seller id=“2”>
73. <questions>
74. <module qid=“8” type=“travel” returnType=“distance” calcMethod=“oneToMany” calcOperation=“sum”>
75. <origins>
76. <origin>
77. <address>
78. <street/>
79. <city>Penrith</city>
80. <state>NSW</state>
81. <country>AU</country>
82. </address>
83. </origin>
84. <origin>
85. <address>
86. <street/>
87. <city>Chatswood</city>
88. <state>NSW</state>
89. <country>AU</country>
90. </address>
91. </origin>
92. </origins>
93. <destinations>
94. <destination>
95. <address>
96. <street/>
97. <city>Bondi</city>
98. <state>NSW</state>
99. <country>AU</country>
100. </address>
101. </destination>
102. </destinations>
103. </module>
104. <module qid=“9” type=“travel” returnType=“travelTime” calcMethod=“oneToMany”
    calcOperation=“sum”>
105. <origins>
106. <origin>
107. <address>
108. <street/>
109. <city>Penrith</city>
110. <state>NSW</state>
111. <country>AU</country>
112. </address>
113. </origin>
114. <origin>
115. <address>
116. <street/>
117. <city>Chatswood</city>
118. <state>NSW</state>
119. <country>AU</country>
120. </address>
121. </origin>
122. </origins>
123. <destinations>
124. <destination>
125. <address>
126. <street/>
127. <city>Bondi</city>
128. <state>NSW</state>
129. <country>AU</country>
130. </address>
131. </destination>
132. </destinations>
133. </module>
134. <q id=“10” type=“number”>20</q>
135. <q id=“11” type=“dateTime”>2002-09-20T00:00:00+10:00</q>
136. <q id=“12” type=“dateTime”>2002-07-20T00:00:00+10:00</q>
137. </questions>
138. </seller>
139. <seller id=“3”>
140. <questions>
141. <module qid=“8” type=“travel” returnType=“distance” calcMethod=“oneToMany”
    calcOperation=“sum”>
142. <origins>
143. <origin>
144. <address>
145. <street/>
146. <city>Parramatta</city>
147. <state>NSW</state>
148. <country>AU</country>
149. </address>
150. </origin>
151. <origin>
152. <address>
153. <street/>
154. <city>Blacktown</city>
155. <state>NSW</state>
156. <country>AU</country>
157. </address>
158. </origin>
159. </origins>
160. <destinations>
161. <destination>
162. <address>
163. <street/>
164. <city>Bondi</city>
165. <state>NSW</state>
166. <country>AU</country>
167. </address>
168. </destination>
169. </destinations>
170. </module>
171. <module qid=“9” type=“travel” returnType=“travelTime” calcMethod=“oneToMany”
    calcOperation=“sum”>
172. <origins>
173. <origin>
174. <address>
175. <street/>
176. <city>Parramatta</city>
177. <state>NSW</state>
178. <country>AU</country>
179. </address>
180. </origin>
181. <origin>
182. <address>
183. <street/>
184. <city>Blacktown</city>
185. <state>NSW</state>
186. <country>AU</country>
187. </address>
188. </origin>
189. </origins>
190. <destinations>
191. <destination>
192. <address>
193. <street/>
194. <city>Bondi</city>
195. <state>NSW</state>
196. <country>AU</country>
197. </address>
198. </destination>
199. </destinations>
200. </module>
201. <q id=“10” type=“number”>20</q>
202. <q id=“11” type=“dateTime”>2002-09-20T00:00:00+10:00</q>
203. <q id=“12” type=“dateTime”>2002-07-20T00:00:00+10:00</q>
204. </questions>
205. </seller>
206. </sellers>
207. <display>
208. <column id=“1” returnType=“all”>
209. <calc type=“sum”>
210. <calc type=“product”>
211. <q id=“13” type=“currency” limit=“10” orderBy=“asc” use=“historical”/>
212. <q id=“10” type=“number” limit=“10” orderBy=“asc” use=“requested”/>
213. </calc>
214. <calc type=“product”>
215. <q id=“14” type=“currency” limit=“10” orderBy=“asc” use=“historical”/>
216. <q id=“8” type=“number” limit=“10” orderBy=“asc” use=“requested”/>
217. </calc>
218. <calc type=“product”>
219. <q id=“15” type=“currency” limit=“10” orderBy=“asc” use=“historical”/>
220. <q id=“9” type=“number” limit=“10” orderBy=“asc” use=“requested”/>
221. </calc>
222. <q id=“16” type=“currency” limit=“10” orderBy=“asc” use=“historical”/>
223. <q id=“17” type=“currency” limit=“10” orderBy=“asc” use=“historical”/>
224. <q id=“18” type=“currency” limit=“10” orderBy=“asc” use=“historical”/>
225. </calc>
226. </column>
227. <column id=“2” returnType=“all”>
228. <calc type=“mean”>
229. <q id=“21” type=“percentage” limit=“10” orderBy=“asc” use=“historical”/>
230. <q id=“21” type=“percentage” limit=“10” orderBy=“asc” use=“historical”/>
231. <q id=“21” type=“percentage” limit=“10” orderBy=“asc” use=“historical”/>
232. <q id=“22” type=“percentage” limit=“10” orderBy=“asc” use=“historical”/>
233. <q id=“22” type=“percentage” limit=“10” orderBy=“asc” use=“historical”/>
234. <q id=“23” type=“percentage” limit=“10” orderBy=“asc” use=“historical”/>
235. </calc>
236. </column>
237. <column id=“3” returnType=“all”>
238. <calc type=“minus”>
239. <q id=“20” type=“dateTime” limit=“10” orderBy=“asc” use=“historical”/>
240. <q id=“12” type=“dateTime” limit=“10” orderBy=“asc” use=“historical”/>
241. </calc>
242. </column>
243. <column id=“4” returnType=“all”>
244. <calc type=“mean”>
245. <c id=“1” type=“norm” stance=“goofy”/>
246. <c id=“2” type=“norm” stance=“natural”/>
247. <c id=“3” type=“norm” stance=“goofy”/>
248. </calc>
249. </column>
250. </display>
251.</request>
```

Annexure B
XML Schema: request.xsd

The following schema defines a valid request.xml file:

```
1.<?xml version=“1.0” encoding=“UTF-8”?>
2.<!-- edited with XML Spy v4.4 U (http://www.xmlspy.com) by doug hudgeon (keen collective) -->
3.<xs:schema targetNamespace=“http://www.smartalloc.net/XMLSchema”
  xmlns:small=“http://www.smartalloc.net/XMLSchema” xmlns:xs=“http://www.w3.org/2001/XMLSchema”
  elementFormDefault=“qualified” attributeFormDefault=“unqualified”>
4.  <xs:element name=“request”>
5. <xs:annotation>
6. <xs:documentation>Request that comes from the front end to the SmartAlloc backend for display of
  sellers</xs:documentation>
7. </xs:annotation>
8. <xs:complexType>
9. <xs:complexContent>
10. <xs:extension base=“small:requestType”/>
11. </xs:complexContent>
12. </xs:complexType>
13. </xs:element>
14. <xs:complexType name=“calcType”>
15. <xs:sequence minOccurs=“0”>
16. <xs:annotation>
17. <xs:documentation>The calculation can be a question in the request (such as 20 hours of surveillance)
  multiplied by the average cost of each seller for each hour of surveillance they conducted in the
  past.</xs:documentation>
18. </xs:annotation>
19. <xs:element name=“calc” type=“small:calcType” minOccurs=“0” maxOccurs=“unbounded”/>
20. <xs:element name=“q” type=“small:qType” minOccurs=“0” maxOccurs=“unbounded”>
21. <xs:annotation>
22. <xs:documentation>Questions can be given additional weighting by including them more than once in
  the column.</xs:documentation>
23. </xs:annotation>
24. </xs:element>
25. <xs:element name=“number” minOccurs=“0”/>
26. <xs:element name=“c” minOccurs=“0” maxOccurs=“unbounded”>
27. <xs:annotation>
28. <xs:documentation>Columns (previous calculations) can be included in the current
  calculation.</xs:documentation>
29. </xs:annotation>
30. <xs:complexType>
31. <xs:attribute name=“id” type=“xs:integer” use=“required”/>
32. <xs:attribute name=“type” use=“required”>
33. <xs:simpleType>
34. <xs:restriction base=“xs:NMTOKEN”>
35. <xs:enumeration value=“norm”/>
36. </xs:restriction>
37. </xs:simpleType>
38. </xs:attribute>
39. <xs:attribute name=“stance” use=“required”>
40. <xs:simpleType>
41. <xs:restriction base=“xs:NMTOKEN”>
42. <xs:enumeration value=“goofy”/>
43. <xs:enumeration value=“natural”/>
44. </xs:restriction>
45. </xs:simpleType>
46. </xs:attribute>
47. </xs:complexType>
48. </xs:element>
49. </xs:sequence>
50. <xs:attribute name=“type”>
51. <xs:simpleType>
52. <xs:restriction base=“xs:NMTOKEN”>
53. <xs:enumeration value=“product”/>
54. <xs:enumeration value=“divide”/>
55. <xs:enumeration value=“minus”/>
56. <xs:enumeration value=“sum”/>
57. <xs:enumeration value=“mean”/>
58. </xs:restriction>
59. </xs:simpleType>
60. </xs:attribute>
61. </xs:complexType>
62. <xs:complexType name=“qType”>
63. <xs:simpleContent>
64. <xs:extension base=“xs:string”>
65. <xs:attribute name=“id” type=“xs:integer” use=“required”/>
66. <xs:attribute name=“type” use=“required”>
67. <xs:simpleType>
68. <xs:restriction base=“xs:NMTOKENS”>
69. <xs:enumeration value=“currency”/>
70. <xs:enumeration value=“number”/>
71. <xs:enumeration value=“percentage”/>
72. <xs:enumeration value=“dateTime”/>
73. </xs:restriction>
74. </xs:simpleType>
75. </xs:attribute>
76. <xs:attribute name=“use” use=“optional”>
77. <xs:annotation>
78. <xs:documentation>“Historical” indicates that the historical data should be used in the calculation;
    “requested” indicates that the requested data should be used.</xs:documentation>
79. </xs:annotation>
80. <xs:simpleType>
81. <xs:restriction base=“xs:NMTOKENS”>
82. <xs:enumeration value=“historical”/>
83. <xs:enumeration value=“requested”/>
84. </xs:restriction>
85. </xs:simpleType>
86. </xs:attribute>
87. <xs:attribute name=“limit” type=“xs:string” use=“optional”/>
88. <xs:attribute name=“orderBy” use=“optional”>
89. <xs:simpleType>
90. <xs:restriction base=“xs:NMTOKENS”>
91. <xs:enumeration value=“asc”/>
92. <xs:enumeration value=“desc”/>
93. </xs:restriction>
94. </xs:simpleType>
95. </xs:attribute>
96. </xs:extension>
97. </xs:simpleContent>
98. </xs:complexType>
99. <xs:complexType name=“requestType”>
100. <xs:sequence>
101. <xs:annotation>
102. <xs:documentation>Each request has two components − Sellers and Display</xs:documentation>
103. </xs:annotation>
104. <xs:element name=“sellers” type=“small:sellersType”>
105. <xs:annotation>
106. <xs:documentation>Sellers includes all of the information needed to return a result for each seller
    you may choose to perform work.</xs:documentation>
107. </xs:annotation>
108. </xs:element>
109. <xs:element name=“display” type=“small:displayType”>
110. <xs:annotation>
111. <xs:documentation>Display lists the comparison criteria for the sellers. For example, quality or cost
    or duration, or a combination of all three.</xs:documentation>
112. </xs:annotation>
113. </xs:element>
114. </xs:sequence>
115. <xs:attribute name=“transactionId” type=“xs:integer” use=“required”/>
116. <xs:attribute name=“requestorId” type=“xs:integer” use=“required”/>
117. </xs:complexType>
118. <xs:complexType name=“displayType”>
119. <xs:sequence>
120. <xs:element name=“column” maxOccurs=“unbounded”>
121. <xs:annotation>
122. <xs:documentation>Each criteria is displayed in a column. Each row in the column corresponds to a
    seller.</xs:documentation>
123. </xs:annotation>
124. <xs:complexType>
125. <xs:sequence>
126. <xs:element name=“calc” type=“small:calcType”>
127. <xs:annotation>
128. <xs:documentation>Define the calculation for the column.</xs:documentation>
129. </xs:annotation>
130. </xs:element>
131. </xs:sequence>
132. <xs:attribute name=“id” type=“xs:integer” use=“required”/>
133. <xs:attribute name=“returnType” use=“required”>
134. <xs:simpleType>
135. <xs:restriction base=“xs:NMTOKEN”>
136. <xs:enumeration value=“highest”/>
137. <xs:enumeration value=“lowest”/>
138. <xs:enumeration value=“all”/>
139. </xs:restriction>
140. </xs:simpleType>
141. </xs:attribute>
142. </xs:complexType>
143. </xs:element>
144. </xs:sequence>
145. </xs:complexType>
146. <xs:complexType name=“sellersType”>
147. <xs:sequence>
148. <xs:element name=“seller” maxOccurs=“unbounded”>
149. <xs:annotation>
150. <xs:documentation>List each seller you want to return results for</xs:documentation>
151. </xs:annotation>
152. <xs:complexType>
153. <xs:sequence>
154. <xs:element name=”questions”>
155. <xs:annotation>
156. <xs:documentation>Questions are the criteria you want to assess the sellers on. For
    example, a question could be “Hours of Surveillance requested”. This requests results for each seller based on the a
    specific number of hours of surveillance.</xs:documentation>
157. </xs:annotation>
158. <xs:complexType>
159. <xs:sequence>
160. <xs:element name=“module” type=“small:moduleType” minOccurs=“0”
    maxOccurs=“unbounded”>
161. <xs:annotation>
162. <xs:documentation>SmartAlloc has some special
    modules, such as the travel module. The travel module takes origin suburb(s) and destination suburb(s) and returns the
    shortest distance each seller would have to travel.</xs:documentation>
163. </xs:annotation>
164. </xs:element>
165. <xs:element name=“q” minOccurs=“0” maxOccurs=“unbounded”>
166. <xs:annotation>
167. <xs:documentation>For standard questions (number of
    hours of surveillance) a straight mathematical calculation can be conducted.</xs:documentation>
168. </xs:annotation>
169. <xs:complexType>
170. <xs:simpleContent>
171. <xs:extension base=“small:qType”/>
172. </xs:simpleContent>
173. </xs:complexType>
174. </xs:element>
175. </xs:sequence>
176. </xs:complexType>
177. </xs:element>
178. </xs:sequence>
179. <xs:attribute name=“id” type=“xs:integer” use=“required”/>
180. </xs:complexType>
181. </xs:element>
182. </xs:sequence>
183. </xs:complexType>
184. <xs:complexType name=“addressType”>
185. <xs:sequence>
186. <xs:element name=“street”/>
187. <xs:element name=“city”/>
188. <xs:element name=“state”/>
189. <xs:element name=“country”/>
190. </xs:sequence>
191. </xs:complexType>
192. <xs:complexType name=“moduleType”>
193. <xs:sequence>
194. <xs:element name=“origins”>
195. <xs:annotation>
196. <xs:documentation>The list of charge-out points for each seller. This data will commonly be received
    from a separate call to a SOAP server that lists the charge-out points of each of seller listed in your
    request.</xs:documentation>
197. </xs:annotation>
198. <xs:complexType>
199. <xs:sequence>
200. <xs:element name=“origin” maxOccurs=“unbounded”>
201. <xs:complexType>
202. <xs:sequence>
203. <xs:element name=“address” type=“small:addressType”/>
204. </xs:sequence>
205. </xs:complexType>
206. </xs:element>
207. </xs:sequence>
208. </xs:complexType>
209. </xs:element>
210. <xs:element name=“destinations”>
211. <xs:annotation>
212. <xs:documentation>List of locations that the work will be conducted in.</xs:documentation>
213. </xs:annotation>
214. <xs:complexType>
215. <xs:sequence>
216. <xs:element name=“destination” maxOccurs=“unbounded”>
217. <xs:complexType>
218. <xs:sequence>
219. <xs:element name=“address” type=“small:addressType”/>
220. </xs:sequence>
221. </xs:complexType>
222. </xs:element>
223. </xs:sequence>
224. </xs:complexType>
225. </xs:element>
226. </xs:sequence>
227. <xs:attribute name=“qid” type=“xs:integer” use=“required”/>
228. <xs:attribute name=“type” use=“required”>
229. <xs:simpleType>
230. <xs:restriction base=“xs:NMTOKENS”>
231. <xs:enumeration value=“travel”/>
232. </xs:restriction>
233. </xs:simpleType>
234. </xs:attribute>
235. <xs:attribute name=“calcMethod” use=“required”>
236. <xs:simpleType>
237. <xs:restriction base=“xs:NMTOKENS”>
238. <xs:enumeration value=“oneToMany”/>
239. </xs:restriction>
240. </xs:simpleType>
241. </xs:attribute>
242. <xs:attribute name=“calcOperation” use=“required”>
243. <xs:simpleType>
244. <xs:restriction base=“xs:NMTOKENS”>
245. <xs:enumeration value=“sum”/>
246. </xs:restriction>
247. </xs:simpleType>
248. </xs:attribute>
249. <xs:attribute name=“returnType” use=“required”>
250. <xs:simpleType>
251. <xs:restriction base=“xs:NMTOKENS”>
252. <xs:enumeration value=“distance”/>
253. <xs:enumeration value=“travelTime”/>
254. </xs:restriction>
255. </xs:simpleType>
256. </xs:attribute>
257. </xs:complexType>
1  </xs:schema>
```

1. A computerised method of enabling a buyer to select a service provider for performing a service, said method including:
(a) processing a service enquiry for a particular service;
(b) retrieving historical cost data associated with said service in respect of a plurality of service providers in response to said service enquiry;
(c) processing said historical cost data to arrive at comparable cost data in respect of said plurality of service providers for enabling the selection of a service provider to perform the particular service;
(d) capturing cost data relating to the provision of the particular service by the selected service provider; and
(e) updating the historical cost data by incorporating said captured cost data
wherein the historical cost data includes corresponding historical service enquiry data, and wherein the step of processing said historical cost data includes processing said related service enquiry data to arrive at comparable cost data.

2. A computerised method as claimed in claim 1 which includes repeating steps (a) to (e) to enable a buyer to select a service provider for the provision of subsequent services with the aid of regularly updated historical cost data.

3. A computerised method as claimed in either claim 1 which includes compiling an historical cost dataset including historical cost data components associated with the provision of at least one similar previous service by each service provider.

4. A computerised method as claimed in claim 1 wherein the service enquiry includes a plurality of service components and the historical cost data includes historical cost data for a plurality of comparable service components, and step (c) includes:
processing said historical cost data to arrive at cost data for each of said service components.

5. A computerised method as claimed in claim 1 wherein the cost data captured in step (d) includes cost data for each of the service components included in the service enquiry.

6. A computerised method as claimed in claim 5 in which the service components include cost per unit of time and/or distance, in combination together with units of time and/or distance.

7. A computerised method as claimed in claim 1 which includes the additional steps of:
(f) retrieving historical quality data associated with said service in respect of a plurality of service providers in response to said enquiry; and
(g) processing said historical quality data to arrive at comparable quality data in respect of said service providers to enable the selection of a service provider to perform the particular service.

8. A computerised method as claimed in claim 7 which includes the additional steps of:
(h) capturing quality data relating to the provision of the particular service by the selected service provider; and
(i) updating the historical quality data to incorporate said captured quality data.

9. A computerised method as claimed in claim 8 which includes:
repeating steps (F) to (i) to assist a buyer to select a service provider for the provision of subsequent services with the aid of regularly updated quality data.

10. A computerised method as claimed in claim 1 which includes:
compiling an historical quality dataset including historical quality data associated with the provision of at least one previous service by each service provider.

11. A computerised method as claimed in claim 7 wherein the historical quality data includes historical quality data for a plurality of performance attributes, and the service request enquiry includes a plurality of comparable performance attribute weightings reflecting the relative importance of at least two of the performance attributes to the buyer.

12. A computerised method as claimed in claim 7 wherein step (g) includes:
processing said historical quality data in respect of each of the performance attributes to arrive at comparable performance data in respect of each performance attribute, and combining said comparable performance data according to performance attribute weightings contained in the service enquiry for each service provider, to generate said comparable quality data.

13. A computerised method as claimed in claim 7 which includes quantifying the quality data relating to selected performance attributes using any derived scale, weighting such performance attributes according to their relative importance, normalising the data relating to one or more of said selected performance attributes and combining them with the similarly normalised historical cost data relating to other selected performance attributes, in combination with an additional weighting factor.

14. A computerised method as claimed in claim 7 wherein the comparable cost data and comparable quality data in respect of each of the service providers is combined to derive a comparable performance index for each service provider for enabling the selection of a service provider to perform the particular service, with the combination of the comparable cost data and comparable quality data being arranged in accordance with weightings reflecting the relative importance of the comparable cost data and comparable quality data to the buyer.

15. (canceled)

16. A computerised method according to claim 1 which includes the steps of capturing service enquiry data associated with the captured cost data, and updating the historical cost data by incorporating said captured service enquiry data.

17. A computerised method of enabling a buyer to select a service provider for performing a service, said method including:
(a) compiling historical cost and quality datasets including historical cost and quality data associated with the provision of at least one previous service by each service provider;
(b) receiving and processing a service enquiry from the buyer for a particular service;
(c) retrieving historical cost and quality data associated with said service in respect of a plurality of service providers in response to said enquiry; and
(d) processing said historical cost and quality data to arrive at comparable cost and quality data in respect of said service providers for enabling the selection of a service provider to perform the particular service.

18. A computerised method as claimed in claim 17 which includes:
(e) capturing cost and quality data relating to the provision of the particular service by the selected service provider; and
(f) updating the historical cost and quality data to incorporate said captured cost and quality data, and repeating steps (b) to (F) to enable a buyer to select a service provider for the provision of subsequent services.

19. A computerised method as claimed in claim 17 which includes formatting the service enquiry into a plurality of service components, and formatting the historical cost and quality data into a plurality of comparable service components, with step (d) including:
processing said historical cost and quality data to arrive at cost and quality data for each of said components.

20. A computer-readable medium having stored thereon executable instructions for causing a computer to perform a method of claim 1.

21. A computer operating under the control of the computer readable medium of claim 20.

22. A computer system to enable a buyer to select a service provider for performing a service, said system including:
an enquiry processing device configured to receive and process a service enquiry for a particular service from the buyer;
a database configured to store historical cost data associated with said service in respect of a plurality of service providers; and
a processor carrying instructions to retrieve and process said historical cost data from said database in response to said query to arrive at comparable cost data in respect of said service providers for enabling the buyer to select a service provider, on the basis of said comparable cost data, to perform the particular service.

23. A computer system as claimed in claim 22 which includes:
a data capture component configured to capture cost data relating to the provision of the particular service by the selected service provider, and updating means to update the historical cost data on the database with said captured cost data.

24. A computer system as claimed in claim 22 in which the system further includes:
a data compilation component configured to compile a dataset including historical cost and quality data associated with the provision of at least one previous service by each service provider.

25. A computer system as claimed in claim 22 wherein the enquiry processing device is configured to additionally retrieve historical quality data associated with said service in respect of a plurality of service providers in response to said enquiry, and the enquiry processing device is configured to generate comparable quality data from said historical quality data in respect of said service providers.

26. A computer system as claimed in claim 25 wherein the historical quality data includes historical quality data for a plurality of performance attributes, and the service request enquiry includes a plurality of comparable performance attribute weightings reflecting the importance of each of the performance attributes to the buyer.

27. A computer system as claimed in claim 26 wherein the processor is configured to process said historical quality data in respect of each of the performance attributes to arrive at comparable performance data in respect of each performance attribute, and to combine the comparable performance data according to the performance attribute weightings included in the service enquiry for each service provider, to generate said comparable quality data.

28. A computer system as claimed in claim 25 wherein the processor is configured to derive a comparable performance index for each service provider by combining the comparable cost data and comparable quality data in respect of each of the service providers with the combination of the comparable cost data and comparable quality data being is performed in accordance with weightings reflecting the relative importance of the comparable cost data and comparable quality data to the buyer.

29. A computer system to enable a buyer to select a service provider for performing a service, said system including:
a database configured to store a first dataset including a plurality of service providers, a plurality of associated services and a plurality of associated historical costs;
a processor in communication with said database, wherein said processor is configured to receive historical cost data associated with each service provider and to generate comparative cost data for each service provider according to a predetermined algorithm; and
a communication device configured to communicate said comparative cost data to said buyer to enable the buyer to select a service provider.

30. A computer system as claimed in claim 29 wherein the predetermined algorithm includes weighting means configured to weight a plurality of received historical cost data according to the respective associated service of the historical cost data, and to generate the comparative cost data in accordance with said weighting.

31. A computer system as claimed in claim 30 wherein said processor includes weighting optimisation means adapted to optimise the weightings applied by the weighting means to the received historical cost data, with the weighting optimisation means utilising an algorithm which has the effect of weighting the most recent data more heavily.

32. A computer system as claimed in claim 29 which further includes data capture means configured to capture cost data associated with a current service provided by a service provider, and updating means adapted to update said first data set to include said cost data associated with the current service provided by a service provider.

33. A computer system as claimed in claim 29 wherein the historical cost data includes a plurality of associated service components and associated historical cost component data; and the processor is configured to generate comparative cost data in respect of each service component for each service provider.

34. A computer system as claimed in claim 27 wherein the data storage means is configured to store a second dataset including a plurality of service providers, a plurality of associated services and a plurality of associated historical quality data, and said processor means is configured to additionally receive historical quality data associated with each service provider and generate comparative quality data for each service provider according to a predetermined algorithm; and said communication means is arranged to communicate said comparative quality data to the buyer to enable the buyer to select a service provider.

35. A computer system as claimed in claim 22 wherein the database is configured to store historical service enquiry data associated with the historical cost data, and wherein the processor executes instructions to retrieve and process said historical cost data in conjunction with said related service enquiry data to arrive at said comparable cost data.

36. A computer system as claimed in claim 23 wherein the data capture component is configured to capture service enquiry data associated with the captured cost data, with the updating means being arranged to update the historical cost data on the database with said captured cost and service enquiry data.

37. (canceled)
